(19) United States
(12) Patent Application Publication
(10) Pub. No.: US 2025/0261111 A1
(43) Pub. Date: Aug. 14, 2025

(54) LINK PROCESSING METHOD, COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(21) Appl. No.: 18/702,434

(22) PCT Filed: Oct. 18, 2021
(86) PCT No.: PCT/CN2021/124485

§ 371 Date: Apr. 18, 2024

(51) Int. Cl. H04W 52/02; H04W 76/15

(52) U.S. Cl. CPC H04W 52/0229; H04W 76/15

(57) ABSTRACT

The method is performed by a non-access point multi-link device (Non-AP MLD), and includes the steps: determining a target link according to a target radio frame; and configuring a station corresponding to the target link in a power saving state.

### CROSS REFERENCE TO RELATED APPLICATIONS

The present disclosure is the U.S. national phase application of International Application No. PCT/CN2021/124485 filed on Oct. 18, 2021, the content of which is incorporated herein by reference in its entirety for all purposes.

### TECHNICAL FIELD

The present disclosure relates to the field of mobile communication technology, in particular to a link processing method and an apparatus thereof, a communication method and an apparatus thereof, an electronic device, and a storage medium.

### BACKGROUND

With the rapid development of mobile communication technology, wireless fidelity (Wi-Fi) technology has made tremendous progress in transmission speed and throughput. At present, the research on Wi-Fi technology includes, for example, transmission in the 320 MHz bandwidth, aggregation and collaboration of multiple frequency bands, etc. Main application scenarios for Wi-Fi technology include, for example, video transmission, augmented reality (AR), virtual reality (VR), etc.

Specifically, the aggregation and collaboration of multiple frequency bands refers to the simultaneous communication between devices in 2.4 GHz, 5.8 GHz, 6 GHz, and other frequency bands. For scenarios where devices communicate simultaneously in multiple frequency bands, a new media access control (MAC) mechanism needs to be defined for managing the communication. In addition, the aggregation and collaboration of multiple frequency bands are expected to support low latency transmission.

### SUMMARY

On one aspect, the present disclosure provides a link processing method, performed by a non-access point multi-link device (Non-AP MLD) that supports multi-link, the method including: determining, based on a target radio frame, a target link; and configuring a station corresponding to the target link in a power-saving state.

On another aspect, the present disclosure provides a communication method, performed by an access point multi-link device (AP MLD) that supports multi-link, the method including: sending a target radio frame to a non-access point multi-link device (Non-AP MLD), to instruct the Non-AP MLD to determine a target link based on the target radio frame, and configure a station corresponding to the target link in a power-saving state.

On another aspect, the present disclosure provides a station device, which is a non-access point multi-link device (Non-AP MLD) that supports multi-link, the station device including: a determination module configured to determine, based on a target radio frame, a target link; and a first configuration module configured to configure a station corresponding to the target link in a power-saving state.

On another aspect, the present disclosure provides an access point device, which is an access point multi-link device (AP MLD) that supports multi-link, the access point device including: a first sending module configured to send a target radio frame to a non-access point multi-link device (Non-AP MLD), to instruct the Non-AP MLD to determine a target link based on the target radio frame, and configure a station corresponding to the target link in a power-saving state.

On another aspect, the present disclosure provides a link processing apparatus, applied to a non-access point multi-link device (Non-AP MLD) that supports multi-link, the apparatus including: a link determination module configured to determine, based on a target radio frame, a target link; and a third configuration module configured to configure a station corresponding to the target link in a power-saving state.

On another aspect, the present disclosure provides a communication apparatus, applied to an access point multi-link device (AP MLD) that supports multi-link, the apparatus including: a second sending module configured to send a target radio frame to a non-access point multi-link device (Non-AP MLD), to instruct the Non-AP MLD to determine a target link based on the target radio frame, and configure a station corresponding to the target link in a power-saving state.

The present disclosure also provide an electronic device including a memory, a processor, and a computer program stored on the memory and capable of running on the processor. The processor executes the program to implement the methods as described in one or more embodiments of the present disclosure.

The present disclosure also provide a computer-readable storage medium having a computer program stored thereon. When the computer program is executed by a processor, the methods as described in one or more embodiments of the present disclosure are caused to be implemented.

The additional aspects and advantages of embodiments of the present disclosure will be partially provided in the following description, which will become apparent from the following description or will be understood through practice of the present disclosure.

### BRIEF DESCRIPTION OF THE DRAWINGS

In order to provide a clearer explanation of technical solutions in embodiments of the present disclosure, a brief introduction to the drawings required in the description of embodiments of the present disclosure will be provided in the following. It is apparent that the drawings are only some of the embodiments of the present disclosure, and for those skilled in the art, other drawings can be obtained based on these drawings without creative efforts.

FIG. 1 is a flowchart of a link processing method according to embodiments of the present disclosure;

FIG. 2 is a schematic diagram of a link between an AP MLD and a Non-AP MLD according to embodiments of the present disclosure;

FIG. 3 is a flowchart of a link processing method according to embodiments of the present disclosure;

FIG. 4 is a flowchart of a link processing method according to embodiments of the present disclosure;

FIG. 5 is a flowchart of a communication method according to embodiments of the present disclosure;

FIG. 6 is a schematic diagram of a structure of a station device according to embodiments of the present disclosure;

FIG. 7 is a schematic diagram of a structure of an access point device according to embodiments of the present disclosure; and

FIG. 8 is a schematic diagram of a structure of an electronic device according to embodiments of the present disclosure.

### DETAILED DESCRIPTION

The term “and/or” in embodiments of the present disclosure describes the association relationship between associated objects, indicating that there can be three kinds of relationships. A and/or B, for example, can indicate the presence of A alone, the presence of A and B simultaneously, and the presence of B alone. The character “/” generally indicates that associated objects have an “or” relationship between them.

The term “multiple” in embodiments of the present disclosure refers to two or more, other quantifiers are similar to this.

A detailed explanation of exemplary embodiments will be provided herein, with examples being illustrated in the drawings. The same reference numerals in different drawings represent the same or similar elements when the following description refers to the drawings, unless otherwise indicated. The implementations described in the following exemplary embodiments do not represent all implementations consistent with the present disclosure, instead, they are only examples of devices and methods consistent with some aspects of the present disclosure as detailed in the appended claims.

The terms used in embodiments of the present disclosure are for the purpose of description of specific embodiments only, and are not intended to limit the embodiments of the present disclosure. Singular forms such as “a”, “said”, and “the” used in embodiments of the present disclosure and the appended claims are also intended to include plural forms, unless other meanings are clearly indicated in the context. It should also be understood that the term “and/or” used in the present disclosure refers to and includes any or all possible combinations of one or more listed items related.

It should be understood that although terms such as first, second, and third may be used to describe various information in embodiments of the present disclosure, such information should not be limited to these terms, which are only used to distinguish information of the same type from each other. For example, without departing from the scope of the present disclosure, the first information can also be referred to as the second information, and similarly, the second information can also be referred to as the first information. The word “if” used herein can be interpreted as “when” or “while” or “in response to determination that”, depending on the context.

A clear and complete description of technical solutions disclosed in the embodiments of the present disclosure will be provided in the following, in conjunction with the drawings. Obviously, the embodiments described are only a part of disclosed embodiments of the present disclosure and not all of them. Based on the embodiments of the present disclosure, all other embodiments obtained by those of ordinary skill in the art without creative efforts fall within the protection scope of the present disclosure.

At present, the maximum bandwidth supported in the aggregation and collaboration of multiple frequency bands is 320 MHz (160 MHz+160 MHz). In addition, 240 MHz (160 MHz+80 MHz) and other bandwidths supported by the existing standard may also be supported.

In the current research on Wi-Fi technology, an enhanced multi-link single radio (eMLSR) mode will be supported. In the eMLSR mode, the non-access point multi-link device (Non-AP MLD) that supports multiple links can listen to multiple links that are in the activated state and continues the subsequent frame interaction on one activated link.

Embodiments of the present disclosure provide a link processing method and an apparatus thereof, a communication method and an apparatus thereof, an electronic device and a storage medium, for providing an operation mechanism for activated links that do not perform the frame interaction in the eMLSR mode.

In some embodiments, the method and the apparatus are based on the same inventive concept. As the principles of solving problems by the method and by the apparatus are similar, reference can be made between embodiments of the apparatus and the method, and the same will not be repeated.

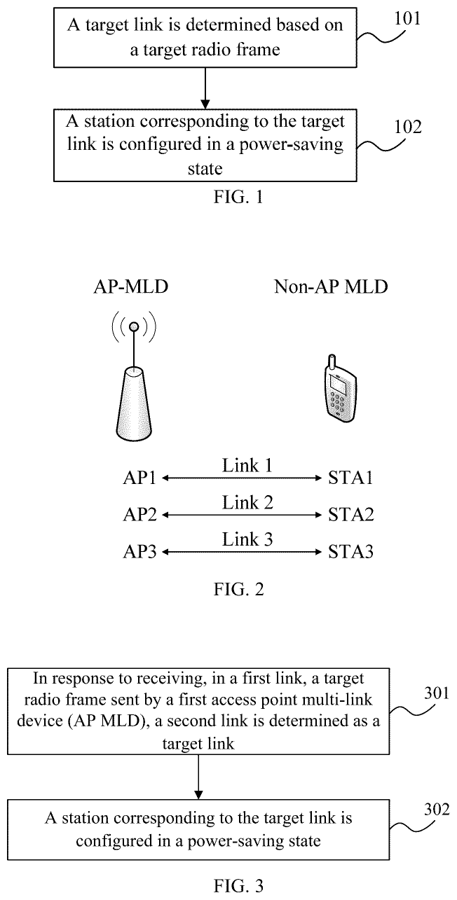

As shown in FIG. 1, embodiments of the present disclosure provide a link processing method. In some embodiments, the method can be applied to a station device that supports multi-link, Non-AP MLD, and the method can include the following steps.

In step 101, a target link is determined based on a target radio frame.

In embodiments of the present disclosure, the access point device and the station device can be devices that support multi-link. For example, the devices can be represented as AP MLD (Access Point Multi-Link Device) and Non-AP MLD (Non-Access Point Multi-Link Device), respectively. For ease of description, an example where an access point device communicates with a station device in multiple links will be mainly described in the following. However, embodiments of the present disclosure are not limited to this.

In some embodiments, as shown in FIG. 2, the AP MLD can represent an access point that supports multi-link communication functionality, and the Non-AP MLD can represent a station that supports multi-link communication functionality. As shown in FIG. 2, the AP MLD can be operated in three links, as designated by AP1, AP2, and AP3 in FIG. 2. Each AP can be operated in (communication) Link 1, Link 2, and Link 3, respectively. The Non-AP MLD can also be operated in three links, as designated by STA1, STA2, and STA3 in FIG. 2. STA1 is operated in Link 1, STA2 is operated in Link 2, and STA3 is operated in Link 3. As shown in FIG. 2, in some embodiments, it is assumed that AP1 and STA1 communicate through corresponding first link Link 1. Similarly, AP2 and STA2 communicate through corresponding second link Link 2,and AP3 and STA3 communicate through corresponding third link Link 3. In some embodiments, Link 1 to Link 3 can be multiple links at different frequencies, such as links at 2.4 GHz, 5 GHz, or 6 GHz, or several links with the same or different bandwidths at 2.4 GHz. In some embodiments, each link can have multiple channels. It can be understood that the communication scenario shown in FIG. 2 is only illustrative, and the present disclosure is not limited to this. For example, the AP MLD can be connected to multiple Non-AP MLDs, or in each link, an AP can communicate with multiple other types of stations.

In the eMLSR mode, the Non-AP MLD can perform a listening operation in multiple links that are in an activated state and continues the subsequent frame interaction in one activated link. In some embodiments, the target radio frame is, for example, an initial control frame, and a listen operation is an operation for such as Channel Clear Assessment (CCA) or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

After initiating the frame interaction, the Non-AP MLD transmits (including sends and receives) radio frames in the link in which the initial control frame is received (referred to as Link1 thereinafter for ease of description), and does not transmit radio frames in other links, until a frame interaction sequence ends. It is found that other links that are in the activated state and do not engage in the frame interaction are in a blind state during the frame interaction performed in Link1, being unable to transmit radio frames or to be listened. Therefore, for the Non-AP MLD, the states of other links during the frame interaction are a waste of power consumption. In embodiments of the present disclosure, for other links, step 102 is executed during the frame interaction.

In step 102, a station corresponding to the target link is configured in a power-saving state.

In some embodiments, the target link refers to the other links mentioned above. During the frame interaction performed in Link1, the station (STA) corresponding to the target link that is in the activated state and does not engage in the frame interaction is configured in the power-saving state, to save the power consumption of the Non-AP MLD.

As shown in FIG. 3, embodiments of the present disclosure provide a link processing method. In some embodiments, the method can be applied to a station device that supports multi-link, Non-AP MLD, and the method can include the following steps.

In step 301, in response to receiving, in a first link, a target radio frame sent by a first access point multi-link device (AP MLD), a second link is determined as a target link. In some embodiments, the second link is a link in an activated state in addition to the first link.

In the eMLSR mode, the Non-AP MLD can perform a listening operation in multiple links that are in the activated state and continues the subsequent frame interaction in one activated link. After initiating the frame interaction, the Non-AP MLD transmits (including sends and receives) radio frames in the link in which the initial target radio frame is received, and does not transmit radio frames in other links, until a frame interaction sequence ends. In some embodiments, the target radio frame is, for example, an initial control frame, and a listen operation is an operation for such as Channel Clear Assessment or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

In some embodiments, the first link is a link in which the frame interaction is performed, while the target link is a link that is in the activated state and does not perform the frame interaction.

In step 302, a station corresponding to the target link is configured in a power-saving state.

According to embodiments of the present disclosure, during the frame interaction performed in the first link, the station corresponding to the target link is configured in the power-saving state, to provide an operation mechanism for the target link, while saving the power consumption of the Non-AP MLD.

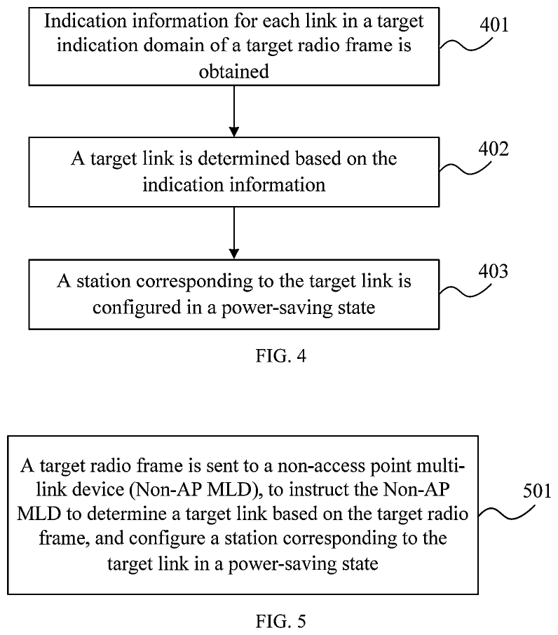

As shown in FIG. 4, embodiments of the present disclosure provide a link processing method. In some embodiments, the method can be applied to a station device that supports multi-link, Non-AP MLD, and the method can include the following steps.

In step 401, indication information for each link in a target indication domain of a target radio frame is obtained.

In the eMLSR mode, the Non-AP MLD can perform a listening operation in multiple links that are in the activated state and continues the subsequent frame interaction in one activated link. After initiating the frame interaction, the Non-AP MLD transmits (including sends and receives) radio frames in the link in which the initial target radio frame is received, and does not transmit radio frames in other links, until a frame interaction sequence ends. In some embodiments, the target radio frame is, for example, an initial control frame, and a listen operation is an operation for such as Channel Clear Assessment or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

Taking the initial control frame as the target radio frame as an example, before sending the initial control frame, the AP MLD adds a target indication domain in the initial control frame and adds indication information in the target indication domain. In some embodiments, the indication information can indicate which links are in the activated state or which links (stations) can enter the power-saving state.

In step 402, a target link is determined based on the indication information.

Based on the indication information for each link in the target indication domain, the link that can enter the power-saving state is determined. For example, if the indication information for a certain link indicates 1, then the identified station corresponding to the link can enter the power-saving state.

In step 403, a station corresponding to the target link is configured in a power-saving state.

In some embodiments, the target link refers to the other links mentioned above. During the frame interaction performed in Link1, the station corresponding to the target link that is in the activated state and does not engage in the frame interaction is configured in the power-saving state, to save the power consumption of the Non-AP MLD.

In some embodiments, before obtaining the indication information for each link in the target indication domain of the target radio frame, the method includes the following steps.

A first radio frame is received, and the indication information is determined based on a value in an enhanced multi-link single radio (eMLSR) mode domain in the first radio frame.

In some embodiments, the first radio frame includes eMLSR mode information for each link. In some embodiments, the first radio frame includes a multi-link mode notification frame, the multi-link mode notification frame includes an eMLSR mode domain, and the eMLSR mode domain includes whether each link supports the eMLSR mode. After receiving the multi-link mode notification frame, the Non-AP MLD determines the indication information based on the value in the eMLSR mode domain. For example, if the eMLSR mode domain indicates that a certain link supports the eMLSR mode, then the Non-AP MLD can determine that the indication information for the link indicates that the link can enter the power-saving state.

In some embodiments, reference is made to Table 1, which shows the eMLSR mode domain in the multi-link mode notification frame for link X.

TABLE 1

| | eMLMR | eMLSR | |
|---|---|---|---|
| Content | mode | mode | Reserved |
| Bits | 1 | 1 | 6 |
| Bits sequence | B0 | B1 | B2 to B7 |

In Table 1, eMLMR represents enhanced Multi-Link Multi-Radio. When the eMLMR mode subfield is set to 1, it indicates that the Non-AP MLD operates in the eMLMR mode. When the eMLMR mode subfield is set to 0, it indicates that the Non-AP MLD does not operate in the eMLMR mode. For the Non-AP MLD that does not support operations of Multi-Link Multi-Radio, the eMLMR mode subfield is set to 0.

When the eMLSR mode (i.e. the eMLSR mode field) is set to 1, it indicates that link X supports the eMLSR mode. The Non-AP MLD can determine based on the value in the eMLSR mode that the indication information for link X indicates that the link can enter the power-saving state.

In some embodiments, the method further includes the following steps.

In response to receiving a radio frame sent by a second AP MLD, a station corresponding to a link to the second AP MLD is configured in a power-saving state.

In some embodiments, after the Non-AP MLD receives the target radio frame sent by an AP MLD, the Non-AP MLD further receives a radio frame sent by another AP MLD (the second AP MLD). For example, in the scenario of simultaneous transmit and receive (STR), the device that supports the STR can perform uplink and downlink communication simultaneously in multiple links. After receiving the target radio frame sent by AP MLD-1, the Non-AP MLD further receives the radio frame sent by AP MLD-2. The radio frame can be the initial control frame or other radio frames. The Non-AP MLD will not respond to the radio frame sent by AP MLD-2, and configure the station corresponding to the link to the second AP MLD in the power-saving state, by referring to the operation on the station corresponding to the target link in previous embodiments.

In some embodiments, the initial control frame mentioned above can be a trigger frame for multi-user request to send (MU-RTS) or a trigger frame for buffer status report poll (BSRP).

In some embodiments, after a station corresponding to the target link is configured in a power-saving state, the method includes: performing a listening operation in the target link after the frame interaction sequence ends.

In some embodiments, after the frame interaction sequence ends, the Non-AP MLD immediately switches back to the activated target link and performs the above listening operation in the target link.

According to embodiments of the present disclosure, the Non-AP MLD determines the target link based on the target radio frame, and configured the station corresponding to the target link in the power-saving state, to provide an operation mechanism for the target link, while saving the power consumption of the Non-AP MLD.

As shown in FIG. 5, embodiments of the present disclosure also provide a communication method. In some embodiments, the method can be applied to an access point device that supports multi-link, AP MLD, and the method can include the following steps.

In step 501, a target radio frame is sent to a non-access point multi-link device (Non-AP MLD), to instruct the Non-AP MLD to determine a target link based on the target radio frame, and configure a station corresponding to the target link in a power-saving state.

In embodiments of the present disclosure, the access point device and the station device can be devices that support multi-link. For example, the devices can be represented as AP MLD (Access Point Multi-Link Device) and Non-AP MLD (Non-Access Point Multi-Link Device), respectively. For ease of description, an example where an access point device communicates with a station device in multiple links will be mainly described in the following. However, embodiments of the present disclosure are not limited to this.

In some embodiments, as shown in FIG. 2, the AP MLD can represent an access point that supports multi-link communication functionality, and the Non-AP MLD can represent a station that supports multi-link communication functionality. As shown in FIG. 2, the AP MLD can be operated in three links, as designated by AP1, AP2, and AP3 in FIG. 2. Each AP can be operated in (communication) Link 1, Link 2, and Link 3, respectively. The Non-AP MLD can also be operated in three links, as designated by STA1, STA2, and STA3 in FIG. 2. STA1 is operated in Link 1, STA2 is operated in Link 2, and STA3 is operated in Link 3. As shown in FIG. 2, in some embodiments, it is assumed that AP1 and STA1 communicate through corresponding first link Link 1. Similarly, AP2 and STA2 communicate through corresponding second link Link 2, and AP3 and STA3 communicate through corresponding third link Link 3. In some embodiments, Link 1 to Link 3 can be multiple links at different frequencies, such as links at 2.4 GHz, 5 GHz, or 6 GHz, or several links with the same or different bandwidths at 2.4 GHz. In some embodiments, each link can have multiple channels. It can be understood that the communication scenario shown in FIG. 2 is only illustrative, and the present disclosure is not limited to this. For example, the AP MLD can be connected to multiple Non-AP MLDs, or in each link, an AP can communicate with multiple other types of stations.

In the eMLSR mode, the Non-AP MLD can perform a listening operation in multiple links that are in an activated state and continues the subsequent frame interaction in one activated link. In some embodiments, the target radio frame is, for example, an initial control frame, and a listen operation is an operation for such as Channel Clear Assessment (CCA) or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

After initiating the frame interaction, the Non-AP MLD transmits (including sends and receives) radio frames in the link in which the initial control frame is received (referred to as Link1 thereinafter for ease of description), and does not transmit radio frames in other links, until a frame interaction sequence ends. Other links that are in the activated state and do not engage in the frame interaction are in a blind state during the frame interaction performed in Link1, being unable to transmit radio frames or to be listened. Therefore, for the Non-AP MLD, the states of other links during the frame interaction are a waste of power consumption. In embodiments of the present disclosure, for other links, step 102 is executed during the frame interaction.

According to embodiments of the present disclosure, the AP MLD sends the target radio frame to the Non-AP MLD, to instruct the Non-AP MLD to determine the target link based on the target radio frame, and configure the station corresponding to the target link in the power-saving state. As a result, during the frame interaction, the station corresponding to the target link that is in the activated state and does not engage in the frame interaction is configured in the power-saving state, so as to save the power consumption of the Non-AP MLD.

In some embodiments, instructing the Non-AP MLD to determine the target link based on the target radio frame includes: instructing the Non-AP MLD to determine, in response to receiving, in a first link, a target radio frame sent by a first access point multi-link device (AP MLD), a second link as the target link. In some embodiments, the second link is a link in an activated state in addition to the first link.

In some embodiments, the first link is a link in which the frame interaction is performed, while the target link is a link that is in the activated state and does not perform the frame interaction. The AP MLD instructs the Non-AP MLD to determine the link in the activated state in addition to the first link as the target link, and to configure, during the frame interaction, the station corresponding to the target link that is in the activated state and does not perform the frame interaction in the power-saving state.

In some embodiments, sending the target radio frame to the non-access point multi-link device (Non-AP MLD) includes: carrying a target indication domain in the target radio frame, and carrying indication information for each link in the target indication domain. The indication information indicates that whether the link can enter the power-saving state.

Taking the initial control frame as the target radio frame as an example, before sending the initial control frame, the AP MLD adds a target indication domain in the initial control frame and adds indication information in the target indication domain, so that the Non-AP MLD can determine based on the target radio frame that whether the link can enter the power-saving state.

In some embodiments, the initial control frame mentioned above can be a trigger frame for multi-user request to send (MU-RTS) or a trigger frame for buffer status report poll (BSRP).

In some embodiments, before sending the target radio frame to the non-access point multi-link device (Non-AP MLD), the method includes the following steps.

A first radio frame is sent to the Non-AP MLD, and the indication information is carried in an enhanced multi-link single radio (eMLSR) mode domain in the first radio frame.

In some embodiments, the first radio frame includes eMLSR mode information for each link. In some embodiments, the first radio frame includes a multi-link mode notification frame, the multi-link mode notification frame includes an eMLSR mode domain, and the eMLSR mode domain includes whether each link supports the eMLSR mode. After receiving the multi-link mode notification frame, the Non-AP MLD determines the indication information based on the value in the eMLSR mode domain. For example, if the eMLSR mode domain indicates that a certain link supports the eMLSR mode, then the Non-AP MLD can determine that the indication information for the link indicates that the link can enter the power-saving state.

In some embodiments, reference is made to Table 1, which shows the eMLSR mode domain in the multi-link mode notification frame for link X.

TABLE 1

| | eMLMR | eMLSR | |
|---|---|---|---|
| Content | mode | mode | Reserved |
| Bits | 1 | 1 | 6 |
| Bits sequence | B0 | B1 | B2 to B7 |

In Table 1, eMLMR represents enhanced Multi-Link Multi-Radio. When the eMLMR mode subfield is set to 1, it indicates that the Non-AP MLD operates in the eMLMR mode. When the eMLMR mode subfield is set to 0, it indicates that the Non-AP MLD does not operate in the eMLMR mode. For the Non-AP MLD that does not support operations of Multi-Link Multi-Radio, the eMLMR mode subfield is set to 0.

When the eMLSR mode (i.e. the eMLSR mode field) is set to 1, it indicates that link X supports the eMLSR mode. The Non-AP MLD can determine based on the value in the eMLSR mode that the indication information for link X indicates that the link can enter the power-saving state.

In some embodiments, the target radio frame includes an initial control frame. In some embodiments, the initial control frame mentioned above can be a trigger frame for multi-user request to send (MU-RTS) or a trigger frame for buffer status report poll (BSRP).

According to embodiments of the present disclosure, the AP MLD sends the target radio frame to the Non-AP MLD, to instruct the Non-AP MLD to determine the target link based on the target radio frame, and configure the station corresponding to the target link in the power-saving state. As a result, during the frame interaction, the station corresponding to the target link that is in the activated state and does not engage in the frame interaction is configured in the power-saving state, so as to save the power consumption of the Non-AP MLD.

Based on the same principle as the methods provided in the present disclosure, embodiments of the present disclosure also provide a station device. The station device is a non-access point multi-link device (Non-AP MLD), which supports multi-link. As shown in FIG. 6, the station device includes a determination module 601 and a first configuration module 602.

The determination module 601 is configured to determine a target link based on a target radio frame.

In the eMLSR mode, the Non-AP MLD can perform a listening operation in multiple links that are in an activated state and continues the subsequent frame interaction in one activated link.

In some embodiments, the target radio frame is, for example, an initial control frame, and a listen operation is an operation for such as Channel Clear Assessment (CCA) or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

After initiating the frame interaction, the Non-AP MLD transmits (including sends and receives) radio frames in the link in which the initial control frame is received (referred to as Link1 thereinafter for ease of description), and does not transmit radio frames in other links, until a frame interaction sequence ends. It is found that other links that are in the activated state and do not engage in the frame interaction are in a blind state during the frame interaction performed in Link1, being unable to transmit radio frames or to be listened. Therefore, for the Non-AP MLD, the states of other links during the frame interaction are a waste of power consumption. In embodiments of the present disclosure, for other links, step 102 is executed during the frame interaction.

The first configuration module 602 is configured to configure a station corresponding to the target link in a power-saving state.

In some embodiments, the target link refers to the other links mentioned above. During the frame interaction performed in Link1, the station (STA) corresponding to the target link that is in the activated state and does not engage in the frame interaction is configured in the power-saving state, to save the power consumption of the Non-AP MLD.

In some embodiments, the determination module 601 includes a first determination submodule.

The first determination submodule is configured to determine, in response to receiving, in a first link, a target radio frame sent by a first access point multi-link device (AP MLD), a second link as a target link. In some embodiments, the second link is a link in an activated state in addition to the first link.

In some embodiments, the determination module 601 includes an obtaining submodule and a second determination submodule.

The obtaining submodule is configured to obtain indication information for each link in a target indication domain of a target radio frame.

The second determination submodule is configured to determine the target link based on the indication information.

In some embodiments, the station device further includes a receiving module and an indication information determination module.

The receiving module is configured to receive a first radio frame.

The indication information determination module is configured to determine the indication information based on a value in an enhanced multi-link single radio (eMLSR) mode domain in the first radio frame.

In some embodiments, the first radio frame includes a multi-link mode notification frame.

In some embodiments, the station device further includes a second configuration module.

The second configuration module is configured to configure, in response to receiving a radio frame sent by a second AP MLD, a station corresponding to a link to the second AP MLD in a power-saving state.

In some embodiments, the station device further includes a listening module.

The listening module is configured to perform a listening operation in the target link after the frame interaction sequence ends.

In some embodiments, the target radio frame includes an initial control frame. In some embodiments, the initial control frame mentioned above can be a trigger frame for multi-user request to send (MU-RTS) or a trigger frame for buffer status report poll (BSRP).

According to the station device provided in the present disclosure, the target link is determined based on the target radio frame through the determination module 601. The station corresponding to the target link is configured in a power-saving state through the first configuration module 602, to provide an operation mechanism for the target link, while saving the power consumption of the Non-AP MLD.

Embodiments of the present disclosure also provide a link processing apparatus. The apparatus is applied to a station device that supports multi-link, Non-AP MLD, and the apparatus includes a link determination module and a third configuration module.

The link determination module is configured to determine a target link based on a target radio frame.

The third configuration module is configured to configure a station corresponding to the target link in a power-saving state.

The apparatus further includes other modules of the station device in the aforementioned embodiments, which will not be repeated here.

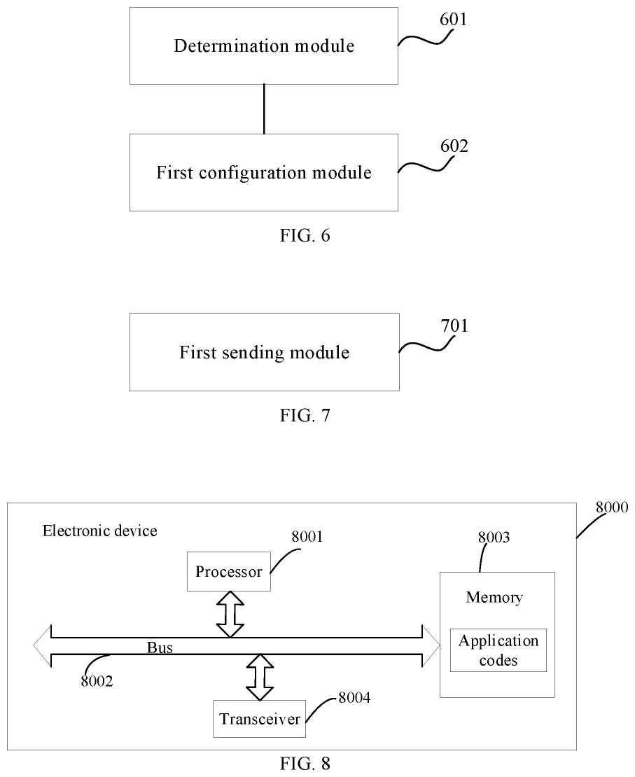

As shown in FIG. 7, embodiments of the present disclosure also provide an access point device. The access point device is an access point multi-link device (AP MLD), which supports multi-link. As shown in FIG. 7, the access point device includes a first sending module 701.

The first sending module 701 is configured to send a target radio frame to a non-access point multi-link device (Non-AP MLD), to instruct the Non-AP MLD to determine a target link based on the target radio frame, and configure a station corresponding to the target link in a power-saving state.

In the eMLSR mode, the Non-AP MLD can perform a listening operation in multiple links that are in an activated state and continues the subsequent frame interaction in one activated link. In some embodiments, the target radio frame is, for example, an initial control frame, and a listen operation is an operation for such as Channel Clear Assessment (CCA) or listening to the initial control frame. The AP MLD sends the initial control frame to one of the links that are in the activated state, to initiate frame interaction with the Non-AP MLD.

In some embodiments, the initial control frame mentioned above can be a trigger frame for multi-user request to send (MU-RTS) or a trigger frame for buffer status report poll (BSRP).

After initiating the frame interaction, the Non-AP MLD transmits (including sends and receives) radio frames in the link in which the initial control frame is received (referred to as Link1 thereinafter for ease of description), and does not transmit radio frames in other links, until a frame interaction sequence ends. Other links that are in the activated state and do not engage in the frame interaction are in a blind state during the frame interaction performed in Link1, being unable to transmit radio frames or to be listened. Therefore, for the Non-AP MLD, the states of other links during the frame interaction are a waste of power consumption. In embodiments of the present disclosure, for other links, step 102 is executed during the frame interaction.

In some embodiments, the first sending module 701 includes a first indication submodule.

The first indication submodule is configured to instruct the Non-AP MLD to determine, in response to receiving, in a first link, a target radio frame sent by a first access point multi-link device (AP MLD), a second link as the target link. In some embodiments, the second link is a link in an activated state in addition to the first link.

In some embodiments, the first sending module 701 is configured to carry a target indication domain in the target radio frame, and carry indication information for each link in the target indication domain. The indication information indicates that whether the link can enter the power-saving state.

In some embodiments, the access point device further includes a third sending module.

A third sending module is configured to send a first radio frame to the Non-AP MLD, and carry the indication information in an enhanced multi-link single radio (eMLSR) mode domain in the first radio frame.

In some embodiments, the first radio frame includes a multi-link mode notification frame.

In some embodiments, the target radio frame includes an initial control frame. In some embodiments, the initial control frame mentioned above can be a trigger frame for multi-user request to send (MU-RTS) or a trigger frame for buffer status report poll (BSRP).

According to embodiments of the present disclosure, the first sending module 701 sends the target radio frame to the Non-AP MLD, to instruct the Non-AP MLD to determine the target link based on the target radio frame, and configure the station corresponding to the target link in the power-saving state. As a result, during the frame interaction, the station corresponding to the target link that is in the activated state and does not engage in the frame interaction is configured in the power-saving state, so as to save the power consumption of the Non-AP MLD.

Embodiments of the present disclosure also provide a communication apparatus. The apparatus is applied to an access point device that supports multi-link, AP MLD, and the apparatus includes a second sending module.

The second sending module is configured to send a target radio frame to a non-access point multi-link device (Non-AP MLD), to instruct the Non-AP MLD to determine a target link based on the target radio frame, and configure a station corresponding to the target link in a power-saving state.

The apparatus further includes other modules of the access point device in the aforementioned embodiments, which will not be repeated here.

In some embodiments, the present disclosure also provides an electronic device, as shown in FIG. 8. The electronic device 8000 shown in FIG. 8 can be a server, including a processor 8001 and a memory 8003. In some embodiments, the processor 8001 is connected to the memory 8003, for example, through bus 8002. In some embodiments, the electronic device 8000 can also include a transceiver 8004. It should be noted that in practical applications, the transceiver 8004 is not limited to one transceiver, and a structure of the electronic device 8000 does not constitute a limitation to embodiments of the present disclosure.

The processor 8001 can be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof, which can implement or execute various exemplary logical blocks, modules, and circuits described in conjunction with the present disclosure. The processor 8001 can also be a combination of computing functions, such as a combination containing one or more microprocessors, a combination containing the DSP and the microprocessor, etc.

The bus 8002 can include a path for delivering information between the aforementioned components. The bus 8002 can be a PCI (Peripheral Component Interconnect) bus or an EISA (Extended Industry Standard Architecture) bus, etc. The bus 8002 can be divided into an address bus, a data bus, a control bus, etc. For ease of representation, only one thick line is used in FIG. 8, but it does not mean that there is only one bus or one type of bus.

The memory 8003 can be ROM (Read Only Memory) or other types of static storage devices that can store static information and instructions, RAM (Random Access Memory) or other types of dynamic storage devices that can store information and instructions, or EEPROM (Electrically Erasable Programmable Read Only Memory), CD-ROM (Compact Disc Read Only Memory), or other optical disk storage devices, optical disc storage devices (including compressed discs, laser discs, optical discs, digital universal discs, Blu-ray discs, etc.), magnetic disk storage media or other magnetic storage devices, or any other media that can be used to carry or store desired program codes in the form of instructions or data structures and can be accessed by computers, but not limited to this.

The memory 8003 is used to store application program codes for implementing the present disclosure, and the execution of the codes is controlled by the processor 8001. The processor 8001 is used to execute the application program codes stored in the memory 8003 to implement the methods provided in the aforementioned method embodiments.

In some embodiments, the electronic device includes but is not limited to mobile phones, laptops, digital broadcasting receivers, PDAs (Personal Digital Assistant), PADs (tablet), PMPs (Portable Multimedia Player), in-vehicle terminals (such as in-vehicle navigation terminals), and fixed terminals such as digital TVs, desktop computers, and so on. The electronic device shown in FIG. 8 is only an example and should not impose any limitations on the functionality and the use scope of embodiments of the present disclosure.

The server provided in the present disclosure can be an independent physical server, a server cluster or a distributed system composed of multiple physical servers, or a cloud server that provides basic cloud computing services such as cloud service, cloud database, cloud computing, cloud function, cloud storage, network service, cloud communication, middleware service, domain name service, security service, CDN, as well as big data and artificial intelligence platform. The terminal can be smartphone, tablet, laptop, desktop computer, smart speaker, smartwatch, etc., but is not limited to this. The terminal and the server can be directly or indirectly connected through wired or wireless communication methods, and the present disclosure is not limited here.

Embodiments of the present disclosure provide a computer-readable storage medium on which a computer program is stored. When the computer program is running on a computer, enables the computer to implement the corresponding content of the aforementioned method embodiments.

It should be understood that although the various steps in the flowchart in the drawings are displayed in sequence indicated by arrows, these steps are not necessarily executed in the order indicated by the arrows. Unless explicitly stated in the article, the execution of these steps does not have strict order restrictions and can be carried out in other orders. Moreover, at least a portion of the steps in the flowchart of the drawings can include multiple sub steps or stages, which may not necessarily be completed at the same time, but may be executed at different times, and their execution order may not necessarily be in sequence, but may rotate or alternate with at least a portion of other steps or sub steps or stages.

It should be noted that the computer-readable medium mentioned in the present disclosure can be a computer-readable signal medium, a computer-readable storage medium, or any combination of the two. The computer-readable storage medium can be, but is not limited to, an electrical, magnetic, optical, electromagnetic, infrared, or semiconductor system, apparatus, or device, or any combination thereof. More specific examples of the computer-readable storage medium can include, but are not limited to: electrical connections with one or more wires, portable computer disks, hard drives, random access memory (RAM), read-only memory (ROM), erasable programmable read-only memory (EPROM or flash), fiber optics, portable compact disk read-only memory (CD-ROM), optical storage devices, magnetic storage devices, or any suitable combination of the above. In the present disclosure, a computer-readable storage medium can be any tangible medium containing or storing a program, which can be used by an instruction execution system, apparatus, or device, or in combination with it. In the present disclosure, the computer-readable signal medium can include data signals propagated in the baseband or as part of the carrier wave, which carry computer-readable program codes. This type of transmitted data signal can take various forms, including but not limited to electromagnetic signals, optical signals, or any suitable combination of the above. The computer-readable signal medium can also be any computer-readable medium other than a computer-readable storage medium, which can send, propagate, or transmit programs for use by an instruction execution system, apparatus, or device, or in combination with it. The program code contained on computer-readable medium can be transmitted using any appropriate medium, including but not limited to: wires, optical cables, RF (radio frequency), etc., or any suitable combination of the above.

The above-mentioned computer-readable medium can be included in the electronic device mentioned above. It can also exist separately without being assembled into the electronic device.

The above-mentioned computer-readable medium carries one or more programs, which, when executed by the electronic device, cause the electronic device to implement the methods shown in the above embodiments.

According to one aspect of the present disclosure, a computer program product or computer program is provided, including computer instructions stored in a computer-readable storage medium. The processor of a computer device reads the computer instruction from the computer-readable storage medium, executes the computer instructions, and causes the computer device to implement the link processing methods and communication methods provided in the various embodiments mentioned above.

The computer program codes for implementing the operations disclosed herein can be written in one or more programming languages or combinations thereof, including object-oriented programming languages such as Java, Smalltalk, C++, and conventional procedural programming languages such as C or similar programming languages. The program codes can be completely executed on the user's computer, partially executed on the user's computer, executed as an independent software package, partially executed on the user's computer and partially executed on a remote computer, or completely executed on the remote computer or a server. In the case where remote computers are involved, the remote computer can be connected to the user computer through any type of networks, including local area networks (LAN) or wide area networks (WAN), or can be connected to an external computer (such as connected via the internet provided by internet service providers).

The flowchart and block diagram in the drawings illustrate the possible architectures, functions, and operations of the systems, methods, and computer program products according to various embodiments of the present disclosure. Each box in a flowchart or block diagram can represent a module, a program segment, or a part of codes that contain one or more executable instructions for implementing a specified logical function. It should also be noted that in some embodiments, the functions indicated in the box can also occur in a different order than those indicated in the drawings. For example, two consecutive boxes can actually be executed in basic parallel order, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or operations, or can be implemented using a combination of dedicated hardware and computer instructions.

The modules described in embodiments of the present disclosure can be implemented through software or hardware. In some embodiments, the name of the module does not constitute a limitation on the module itself in a certain situation. For example, module A can also be described as “module A used to perform operation B”.

The above description is only for embodiments of the present disclosure and an explanation of the technical principles involved. Those skilled in the art should understand that the scope of the present disclosure is not limited to technical solutions formed by specific combinations of the technical features mentioned above, and should also cover other technical solutions formed by arbitrary combinations of the technical features mentioned above or their equivalent features without departing from the concept disclosed. For example, a technical solution formed by replacing the above features with technical features with similar functions disclosed (but not limited to) in the present disclosure.

1. A link processing method, performed by a non-access point multi-link device (Non-AP MLD) that supports multi-link, the method comprising:
determining, based on a target radio frame, a target link; and
configuring a station corresponding to the target link in a power-saving state.

2. The link processing method according to claim 1, wherein determining, based on the target radio frame, the target link, comprises:
determining, in response to receiving, in a first link, the target radio frame sent by a first access point multi-link device (AP MLD), a second link as the target link, wherein the second link is a link in an activated state in addition to the first link.

3. The link processing method according to claim 1, wherein determining, based on the target radio frame, the target link, comprises:
obtaining indication information for each link in a target indication domain of the target radio frame; and
determining, based on the indication information, the target link.

4. The link processing method according to claim 3, further comprising:
receiving a first radio frame; and
determining the indication information based on a value in an enhanced multi-link single radio (eMLSR) mode domain in the first radio frame.

5. The link processing method according to claim 4, wherein the first radio frame comprises a multi-link mode notification frame.

6. The link processing method according to claim 1, further comprising:
configuring, in response to receiving a radio frame sent by a second AP MLD, a station corresponding to a link to the second AP MLD in the power-saving state.

7. The link processing method according to claim 1, further comprising:
performing a listening operation in the target link after a frame interaction sequence ends.

8. The link processing method according to claim 1, wherein the target radio frame comprises an initial control frame.

9. A communication method, performed by an access point multi-link device (AP MLD) that supports multi-link, the method comprising:
sending a target radio frame to a non-access point multi-link device (Non-AP MLD), to instruct the Non-AP MLD to determine a target link based on the target radio frame, and configure a station corresponding to the target link in a power-saving state.

10. The communication method according to claim 9, wherein instructing the Non-AP MLD to determine the target link based on the target radio frame comprises:
instructing the Non-AP MLD to determine, in response to receiving, in a first link, the target radio frame sent by a first access point multi-link device (AP MLD), a second link as the target link, wherein the second link is a link in an activated state in addition to the first link.

11. The communication method according to claim 9, wherein sending the target radio frame to the non-access point multi-link device (Non-AP MLD) comprises:
carrying a target indication domain in the target radio frame, and carrying indication information for each link in the target indication domain, wherein the indication information indicates that whether the link can enter the power-saving state.

12. The communication method according to claim 11, further comprising:
sending a first radio frame to the Non-AP MLD; and
carrying the indication information in an enhanced multi-link single radio (eMLSR) mode domain in the first radio frame.

13. The communication method according to claim 12, wherein the first radio frame comprises a multi-link mode notification frame.

14. The communication method according to claim 9, wherein the target radio frame comprises an initial control frame.

15.-18. (canceled)

19. An electronic device comprising a memory, a processor, and a computer program stored on the memory and capable of running on the processor, wherein the processor is configured to:
determine, based on a target radio frame, a target link; and
configure a station corresponding to the target link in a power-saving state.

20. A non-transitory computer-readable storage medium having a computer program stored thereon, wherein the method according to claim 1 is caused to be implemented when the computer program is executed by a processor.

21. An electronic device comprising a memory, a processor, and a computer program stored on the memory and capable of running on the processor, wherein the processor executes the program to implement the method according to claim 9.

22. A non-transitory computer-readable storage medium having a computer program stored thereon, wherein the method according to claim 9 is caused to be implemented when the computer program is executed by a processor.

23. The link processing method according to claim 8, wherein the initial control frame comprises a trigger frame for multi-user request to send (MU-RTS), or a trigger frame for buffer status report poll (BSRP).

24. The communication method according to claim 14, wherein the initial control frame comprises a trigger frame for multi-user request to send (MU-RTS), or a trigger frame for buffer status report poll (BSRP).
